(19) United States
(12) Patent Application Publication
(10) Pub. No.: US 2017/0149380 A1
(43) Pub. Date: May 25, 2017

(54) EMBEDDED PHOTOVOLTAIC MONITORING DEVICE, SYSTEM AND METHOD

(71) Applicant: Da-Yeh University, Dacun (TW)

(72) Inventors: Huan-Liang TSAI, Dacun (TW); Phuong Truong LE, Dacun (TW)

(21) Appl. No.: 14/945,797

(22) Filed: Nov. 19, 2015

(51) Int. Cl. H02S 50/10

(52) U.S. Cl. CPC H02S 50/10

(57) ABSTRACT

An embedded PV monitoring device comprises a data receiving unit, a processing unit, a simulating unit and an evaluating unit. An embedded PV monitor system comprises a PV unit, a sensing unit and an embedded PV monitoring device. An embedded PV monitor method mainly utilizes the monitoring device to receive voltage and current parameters of the PV module and an environment working parameter. An output current and an output power of the PV module can be actually calculated, while the output current and the output power of the PV module can be simulated and estimated according to the voltage parameter and the environment working parameter. Thus, the field test monitoring and evaluating on the PV module can be automatically performed and a warning message can be timely outputted. This is advantageous to the detection of the yield of the PV module and the increase of the production quality.

### BACKGROUND OF THE INVENTION

Field of the Invention

The invention relates in general to a monitoring device, a monitoring system and a monitoring method, and more particularly to an embedded photovoltaic (PV) monitoring device, an embedded PV monitoring system and an embedded PV monitoring method.

Related Art

At present, the inspection and evaluation technology for a PV cell, a PV module or an PV array is usually performed using a data acquisition meter (e.g., a data collector of Agilent 34790A) or the equipment based on the laboratory virtual instrumentation engineering workbench (LabVIEW), and then the measured data are simulated and evaluated according to different simulation models (e.g., circuit simulator, Mathematics or MATLAB/Simulink).

However, because the platforms for measurement and evaluation are different from each other, the inspection and evaluation for the PV cell, the PV module or the PV array cannot be automatically performed at a time, so that the required investment cost and the required manpower are higher.

In view of this, an embedded PV monitoring device, an embedded PV monitoring system and an embedded PV monitoring method are needed to solve the above-mentioned problems.

### SUMMARY OF THE INVENTION

A main object of the invention is to provide an embedded PV monitoring device, which is capable of receiving an electrical parameter and an environment working parameter of a PV module and thus measuring, simulating and estimating an output power and an output current of the PV module.

To achieve the above-identified object, the invention provides an embedded PV monitoring device comprising a data receiving unit, a processing unit, a simulating unit and an evaluating unit. The data receiving unit receives a first electrical parameter of a PV module and an environment working parameter. The processing unit is electrically connected to the data receiving unit, and calculates a second electrical parameter according to the first electrical parameter. The simulating unit is electrically connected to the data receiving unit, receives a voltage parameter of the first electrical parameter and the environment working parameter, and simulates and estimates a third electrical parameter according to the voltage parameter and the corresponding environment working parameter. The evaluating unit is electrically connected to the data receiving unit and the simulating unit, compares the second electrical parameter with the corresponding third electrical parameter, generates an error, judges whether the error is higher than a threshold value, and outputs a warning message.

In one embodiment, the first electrical parameter comprises the voltage parameter and a current parameter.

In one embodiment, the second electrical parameter comprises a first current parameter and a first power parameter, and the third electrical parameter comprises a second current parameter and a second power parameter.

Another object of the invention is to provide an embedded PV monitoring system capable of automatically measuring, simulating and estimating an output power and an output current of a PV module. When the measured and simulated errors are too high, the warning message can be outputted, and this is advantageous to the increase of the production quality of PV electricity.

To achieve the above-identified object, the invention provides an embedded PV monitoring system comprising a PV unit, a sensing unit and an embedded PV monitoring device. The PV unit comprises a PV module for converting an optical energy into an electrical energy, which comprises one or multiple first electrical parameters. The sensing unit senses an environment working parameter of the PV module. The embedded PV monitoring device comprises a data receiving unit, a processing unit, a simulating unit and an evaluating unit. The data receiving unit is electrically connected to the PV module and the sensing unit, and receives the first electrical parameter and the environment working parameter. The processing unit is electrically connected to the data receiving unit, and calculates a second electrical parameter according to the first electrical parameter. The simulating unit is electrically connected to the data receiving unit, receives a voltage parameter of the first electrical parameter and the environment working parameter, and simulates and estimates a third electrical parameter according to the voltage parameter and the environment working parameter. The evaluating unit is electrically connected to the data receiving unit and the simulating unit, compares the second electrical parameter with the third electrical parameter to generate an error, judges whether the error is higher than a threshold value and outputs a warning message.

Still another object of the invention is to provide an embedded PV monitoring method, which automatically measures, simulates and estimates an output power and an output current of a PV module, and evaluates an error to effectively detect the yield of the PV cell.

To achieve the above-identified object, the invention provides an embedded PV monitoring method comprising the steps of: providing an embedded PV monitoring system, comprising a PV unit, a sensing unit and an embedded PV monitoring device, wherein the embedded PV monitoring device comprises a data receiving unit, a processing unit, a simulating unit and an evaluating unit; utilizing the PV unit to convert an optical energy into an electrical energy, wherein the electrical energy comprises one or multiple first electrical parameters; utilizing the sensing unit to sense one or multiple environment working parameters of the PV unit; utilizing the data receiving unit to receive each of the first electrical parameters and each of the environment working parameters; utilizing the processing unit to calculate a second electrical parameter according to each of the first electrical parameters and the corresponding one of the environment working parameters; utilizing the simulating unit to receive a voltage parameter of each of the first electrical parameters and each of the environment working parameters, and to simulate and estimate a third electrical parameter according to each of the voltage parameters and the corresponding one of the environment working parameters; and utilizing the evaluating unit to compare each of the second electrical parameters with a corresponding one of the third electrical parameters to generate an error, to judge whether the error is higher than a threshold value and to output a warning message.

The characteristics of the invention will be described in the following. With the embedded PV monitoring device, system and method, the first electrical parameter (voltage and current parameters) of the PV module and the environment working parameter can be received. The output current (i.e., the first current parameter) and the output power (i.e., the first power parameter) of the PV module can be actually calculated, while the output current (i.e., the second current parameter) and the output power (i.e., the second power parameter) of the PV module can also be simulated and estimated according to the voltage parameter and the environment working parameter, so that the field test monitoring and evaluating of the PV module can be automatically performed. When the measured and simulated errors are too high, the warning message can be outputted to assist in increasing the production quality of PV electricity.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a schematic flow chart showing an embedded PV monitoring method according to an embodiment of the invention.

FIG. 2 is a schematic view showing the architecture of an embedded PV monitoring system according to an embodiment of the invention.

FIG. 3 is a graph showing measured data of a solar irradiance parameter and an ambient temperature parameter.

FIG. 4a is a data comparison graph showing a measured first current parameter and a simulated second current parameter.

FIG. 4b is an error data graph showing a first current parameter and a second current parameter.

FIG. 5a is a data comparison graph showing a measured first power parameter and a simulated second power parameter.

FIG. 5b is an error data graph showing a first power parameter and a second power parameter.

### DETAILED DESCRIPTION OF THE INVENTION

The present invention will be apparent from the following detailed description, which proceeds with reference to the accompanying drawings, wherein the same references relate to the same elements.

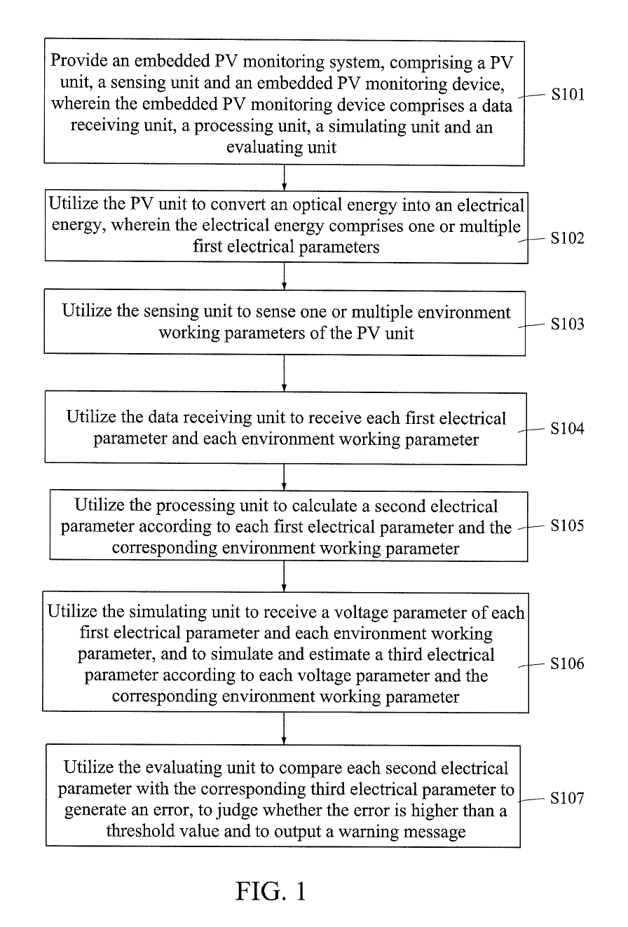

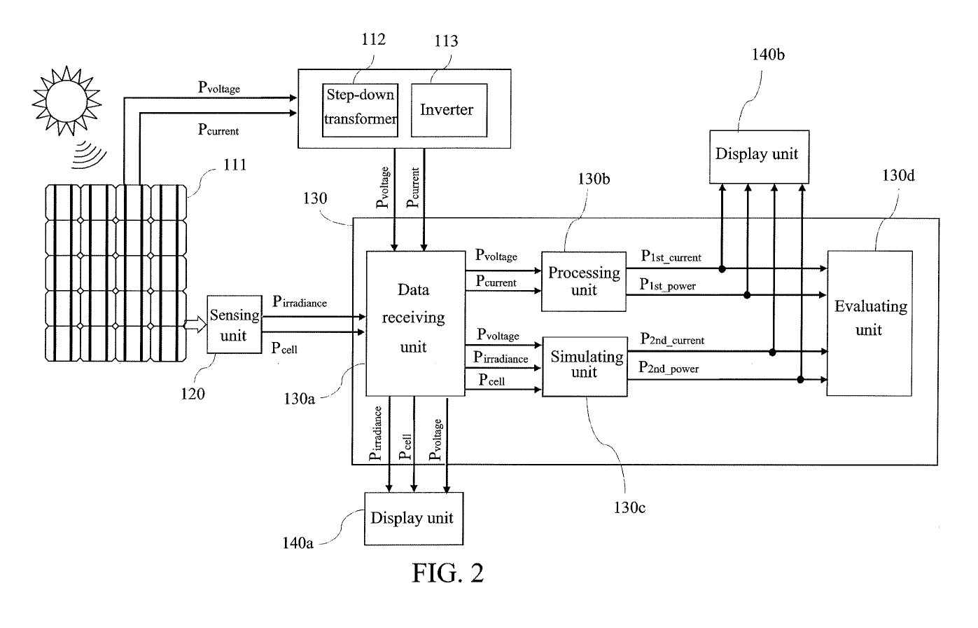

FIG. 1 is a schematic flow chart showing an embedded PV monitoring method according to an embodiment of the invention. FIG. 2 is a schematic view showing the architecture of an embedded PV monitoring system according to an embodiment of the invention.

Referring to FIGS. 1 and 2, the embedded PV monitoring method of this embodiment comprises the following steps.

In step S101, an embedded PV monitoring system is provided. The embedded PV monitoring system 10 comprises: a PV unit, a sensing unit 120 and an embedded PV monitoring device 130, which comprises a data receiving unit 130a, a processing unit 130b, a simulating unit 130cand an evaluating unit 130d.

In step S102, the PV unit is utilized to convert an optical energy into an electrical energy. The electrical energy comprises one or multiple first electrical parameters. Specifically speaking, the PV unit comprises a PV module 111, such as a PV cell, a PV module or a PV array, for converting the optical energy into the electrical energy. In addition, the first electrical parameter of the electrical energy comprises a voltage parameter P_{voltage} and a current parameter P_{current}.

In this embodiment, the PV unit may further comprise a step-down transformer 112 (e.g., DC step-down transformer) and/or an inverter 113 (e.g., PV inverter). When the receiving terminal of the back end of the PV module 111 only receives the low-voltage DC power, the step-down transformer 112 can perform the step-down transformation on the electrical energy provided by the PV module 111. Alternatively, when the receiving terminal only receives the AC power, the inverter 113 can convert a DC power of the electrical energy provided by the PV module 111 into an AC power according to the user's requirement.

In step S103, the sensing unit is used to sense one or multiple environment working parameters of the PV unit. Specifically speaking, the sensing unit 120 senses one or multiple environment working parameters of the PV module 111 of the PV unit, and the environment working parameter comprises a solar irradiance parameter P_{irradiance} and an ambient temperature parameter P_{cell}.

In step S104, the data receiving unit is utilized to receive each of the first electrical parameters and each of the environment working parameters. Specifically speaking, the data receiving unit 130a receives the first electrical parameter and the environment working parameter of the PV module 111.

In step S105, the processing unit is utilized to calculate a second electrical parameter according to each of the first electrical parameters and the corresponding one of the environment working parameters. Specifically speaking, the processing unit 130b is electrically connected to the data receiving unit 130a, and calculates the second electrical parameter, comprising a first current parameter P₁ₛₜ_{_}_{current} and a first power parameter P₁ₛₜ_{_}_{power}, according to the voltage parameter P_{voltage} and the current parameter P_{current} of the first electrical parameter, wherein the first current parameter P₁ₛₜ_{_}_{current} is equal to the current parameter P_{current}.

In step S106, the simulating unit is utilized to receive a voltage parameter of each of the first electrical parameters and each of the environment working parameters, simulate and estimate a third electrical parameter according to each of the voltage parameters and the corresponding one of the environment working parameters. Specifically speaking, the simulating unit 130cis electrically connected to the data receiving unit 130a, and receives the voltage parameter P_{voltage} of each of the first electrical parameters and the solar irradiance parameter P_{irradiance} and the ambient temperature parameter P_{cell} of each of the environment working parameters to simulate and calculate the third electrical parameter comprising a second current parameter P_{2nd}_{_}_{current} and a second power parameter P_{2nd}_{_}_{power}.

In step S107, the evaluating unit is utilized to compare each of the second electrical parameters with a corresponding one of the third electrical parameters, to generate an error, to judge whether the error is higher than a threshold value and to output a warning message.

Specifically speaking, the evaluating unit 130d is electrically connected to the data receiving unit 130a and the simulating unit 130c.

The threshold value comprises a first threshold value and a second threshold value. The error is generated by analyzing a root mean square error (RMSE) and a RMSE in percentage. The error comprises: a first error and a second error, wherein the first error is the error between the first current parameter P₁ₛₜ_{_}_{current} and the second current parameter P_{2nd}_{_}_{current}, and the second error is the error between the first power parameter P₁ₛₜ_{_}_{power} and the second power parameter P_{2nd}_{_}_{power}.

When the first error is higher than the first threshold value, a first warning message of the warning message is outputted. When the second error is higher than the second threshold value, a second warning message of the warning message is outputted. The warning message may be a warning tone or a warning light.

In this embodiment, the embedded PV monitoring system 10 further comprises one or multiple display units (two display units 140a and 140b are shown in the example of FIG. 2) for displaying one or multiple ones of the first electrical parameter, the environment working parameter, the second electrical parameter, the third electrical parameter and the error. Specifically speaking, the display unit 140a is electrically connected to the data receiving unit 130a, and displays the voltage parameter P_{voltage} of the first electrical parameter, and the solar irradiance parameter P_{irradiance} and the ambient temperature parameter P_{cell} of the environment working parameter. The display unit 140b is electrically connected to the processing unit 130b and the simulating unit 130c, and displays the first current parameter P₁ₛₜ_{_}_{current} and the first power parameter P₁ₛₜ_{_}_{power} of the second electrical parameter, and the second current parameter P_{2nd}_{_}_{current} and the second power parameter P_{2nd}_{_}_{power} of the third electrical parameter.

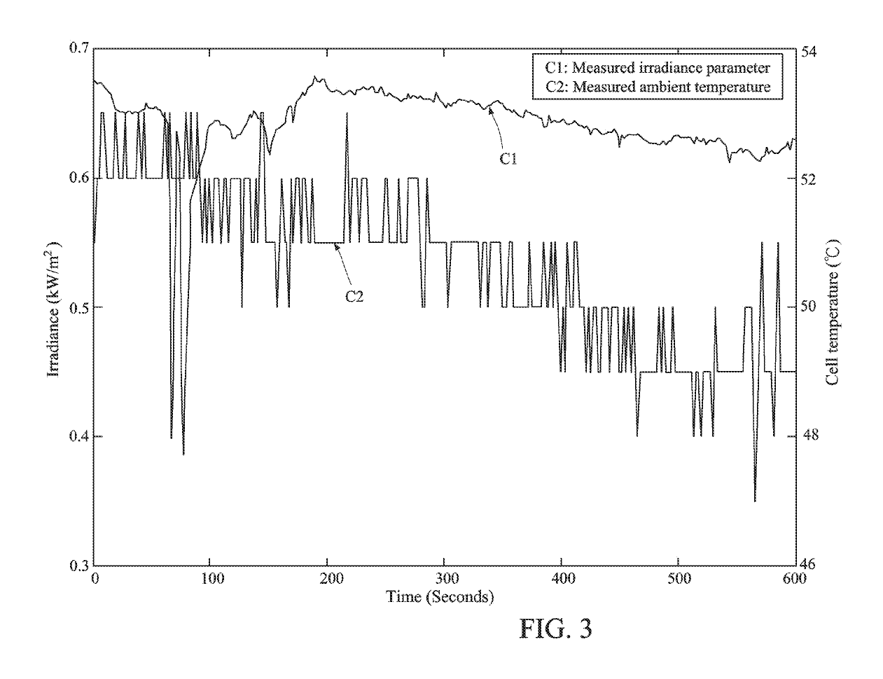

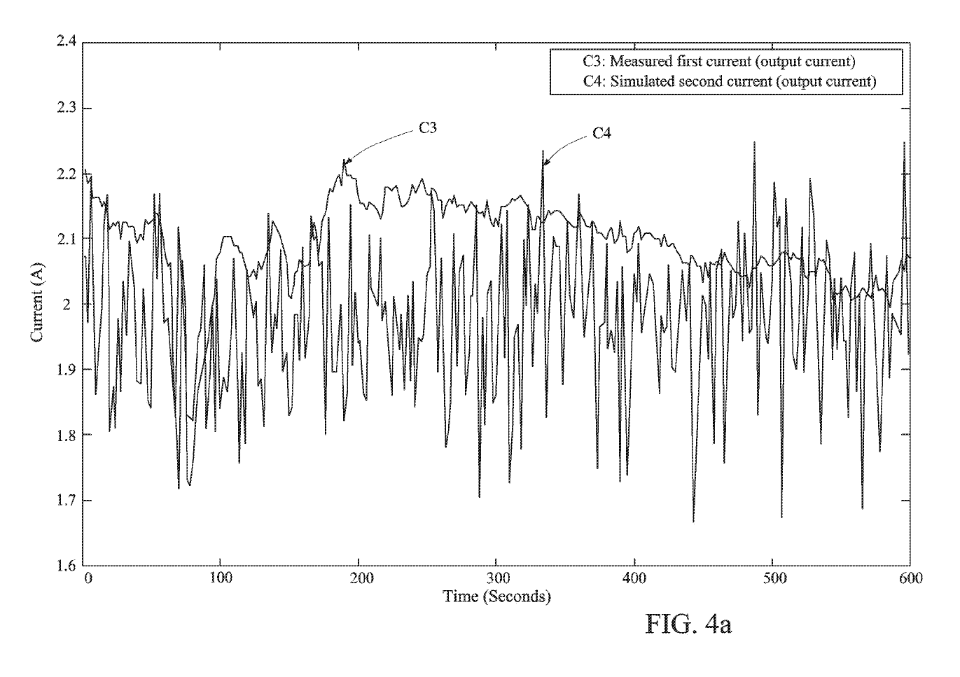

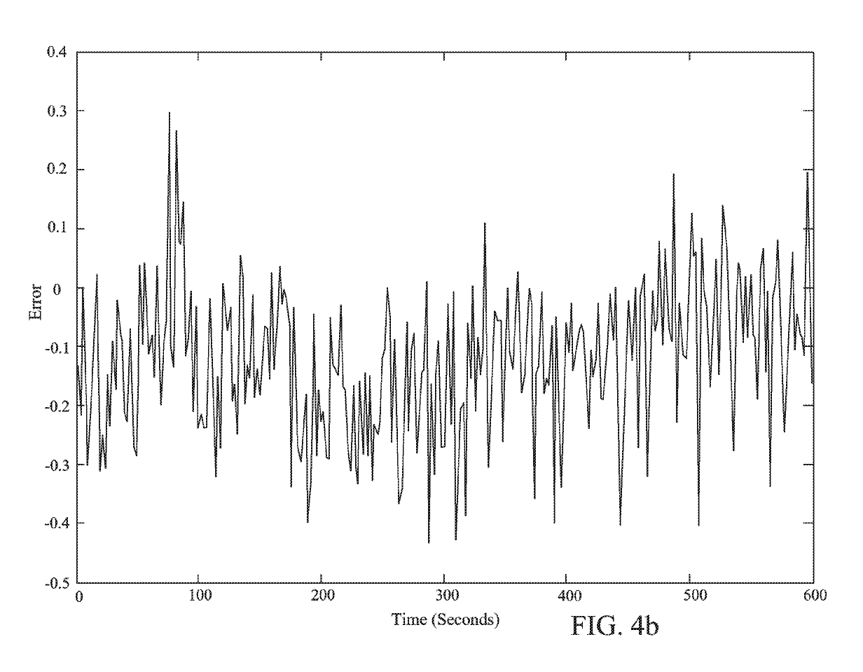

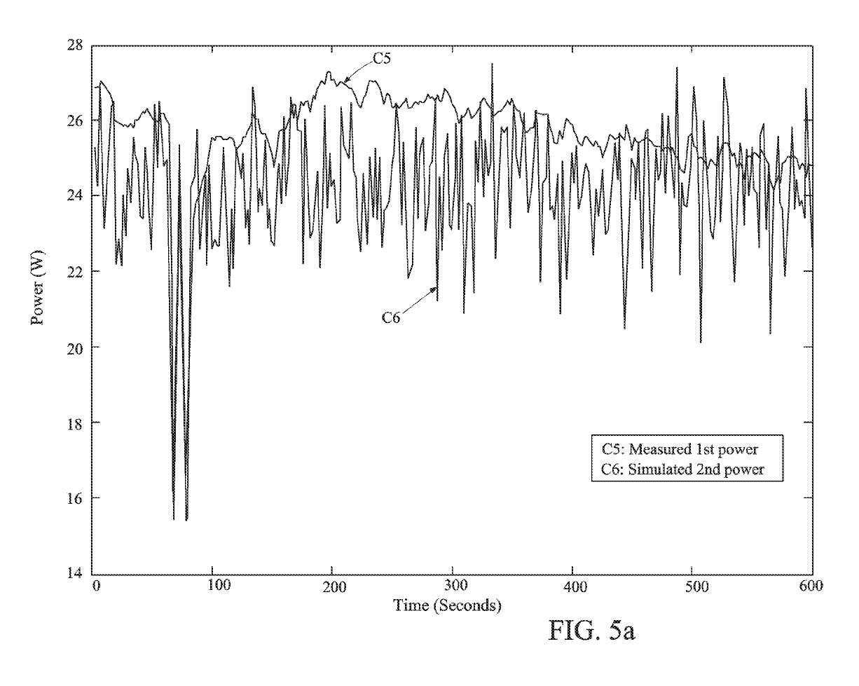

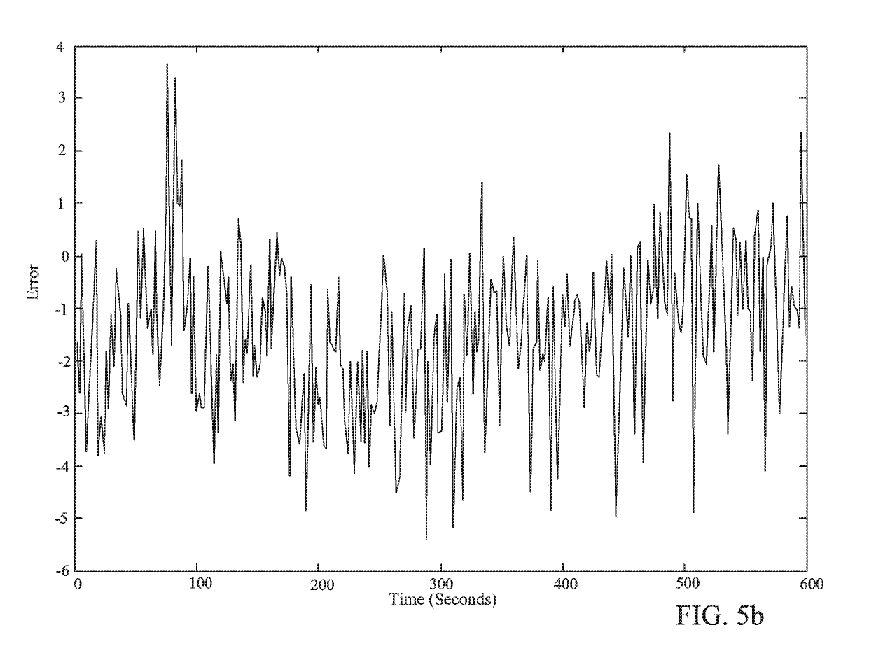

FIG. 3 is a graph showing measured data of a solar irradiance parameter and an ambient temperature parameter. FIG. 4a is a data comparison graph showing a measured first current parameter and a simulated second current parameter. FIG. 4b is an error data graph showing a first current parameter and a second current parameter. FIG. 5a is a data comparison graph showing a measured first power parameter and a simulated second power parameter. FIG. 5b is an error data graph showing a first power parameter and a second power parameter.

TABLE 1

| Output current | | Output power | |
|---|---|---|---|
| RMSE (A) | RMSE (%) | RMSE (W) | RMSE (%) |
| 0.0098 | 0.5346 | 2.228 | 0.5346 |

Referring to FIGS. 2 to 5b and Table 1, it is obtained that in the time period of 600 seconds at a certain time, the error between the output current (i.e., the first current parameter) actually measured and calculated by the processing unit 130b, and the output current (i.e., the second current parameter) simulated and estimated by the simulating unit 130cis smaller than 1%. The error between the output power (i.e., the first power parameter) actually measured and calculated by the processing unit 130b, and the output power (i.e., the second power parameter) simulated and estimated by the simulating unit 130cis also smaller than 3%.

Therefore, the embedded PV monitoring device of the invention can effectively perform the one-time automatic field test monitoring and evaluating on the PV cell. When the measured and simulated errors are too high, the warning message can be outputted to assist in increasing the production quality of PV electricity.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. An embedded photovoltaic (PV) monitoring device, comprising:
a data receiving unit for receiving a first electrical parameter of a PV module and an environment working parameter;
a processing unit, which is electrically connected to the data receiving unit, and calculates a second electrical parameter according to the first electrical parameter;
a simulating unit, which is electrically connected to the data receiving unit, receives a voltage parameter of the first electrical parameter and the environment working parameter, and simulates and estimates a third electrical parameter according to the voltage parameter and the corresponding environment working parameter; and
an evaluating unit, which is electrically connected to the data receiving unit and the simulating unit, compares the second electrical parameter with the corresponding third electrical parameter, generates an error, judges whether the error is higher than a threshold value, and outputs a warning message.

2. The embedded PV monitoring system according to claim 1, wherein the environment working parameter comprises a solar irradiance parameter and an ambient temperature parameter.

3. The embedded PV monitoring system according to claim 1, wherein the first electrical parameter comprises the voltage parameter and a current parameter.

4. The embedded PV monitoring system according to claim 1, wherein:
the second electrical parameter comprises a first current parameter and a first power parameter; and
the third electrical parameter comprises a second current parameter and a second power parameter.

5. The embedded PV monitoring system according to claim 4, wherein:
the threshold value comprises a first threshold value and a second threshold value; and
the error comprises:
a first error, which is an error between the first current parameter and the second current parameter; and
a second error, which is an error between the first power parameter and the second power parameter, wherein:
when the first error is higher than the first threshold value, a first warning message of the warning message is outputted; and
when the second error is higher than the second threshold value, a second warning message of the warning message is outputted.

6. An embedded photovoltaic (PV) monitoring system, comprising:
a PV unit comprising a PV module for converting an optical energy into an electrical energy, which comprises one or multiple first electrical parameters;
a sensing unit for sensing an environment working parameter of the PV module; and
an embedded PV monitoring device, comprising:
a data receiving unit, which is electrically connected to the PV module and the sensing unit, and receives the first electrical parameter and the environment working parameter;
a processing unit, which is electrically connected to the data receiving unit, and calculates a second electrical parameter according to the first electrical parameter; and
a simulating unit, which is electrically connected to the data receiving unit, receives a voltage parameter of the first electrical parameter and the environment working parameter, and simulates and estimates a third electrical parameter according to the voltage parameter and the environment working parameter; and
an evaluating unit, which is electrically connected to the data receiving unit and the simulating unit, compares the second electrical parameter with the third electrical parameter to generate an error, judges whether the error is higher than a threshold value and outputs a warning message.

7. The embedded PV monitoring system according to claim 6, further comprising one or multiple display units, which are electrically connected to the data receiving unit, the processing unit and the simulating unit, and display one or multiple ones of the first electrical parameter, the environment working parameter, the second electrical parameter, the third electrical parameter and the error.

8. The embedded PV monitoring system according to claim 6, wherein the PV unit further comprises:
a step-down transformer for step-down transforming the electrical energy provided by the PV module; and/or
an inverter for converting a DC power of the electrical energy, provided by the PV module, into an AC power.

9. An embedded photovoltaic (PV) monitoring method, comprising the steps of:
providing an embedded PV monitoring system, comprising a PV unit, a sensing unit and an embedded PV monitoring device, wherein the embedded PV monitoring device comprises a data receiving unit, a processing unit, a simulating unit and an evaluating unit;
utilizing the PV unit to convert an optical energy into an electrical energy, wherein the electrical energy comprises one or multiple first electrical parameters;
utilizing the sensing unit to sense one or multiple environment working parameters of the PV unit;
utilizing the data receiving unit to receive each of the first electrical parameters and each of the environment working parameters;
utilizing the processing unit to calculate a second electrical parameter according to each of the first electrical parameters and the corresponding one of the environment working parameters;
utilizing the simulating unit to receive a voltage parameter of each of the first electrical parameters and each of the environment working parameters, and to simulate and estimate a third electrical parameter according to each of the voltage parameters and the corresponding one of the environment working parameters; and
utilizing the evaluating unit to compare each of the second electrical parameters with a corresponding one of the third electrical parameters to generate an error, to judge whether the error is higher than a threshold value and to output a warning message.

10. The embedded PV monitoring method according to claim 9, wherein the error is generated by analyzing a root mean square error (RMSE) and a RMSE in percentage.
